(19) United States
(12) Patent Application Publication
(10) Pub. No.: US 2020/0001694 A1
(43) Pub. Date: Jan. 2, 2020

(54) MOBILITY SCOOTER TILLER COVER

(71) Applicant: Patricia Schuessler, Homasassa, FL (US)

(72) Inventor: Patricia Schuessler, Homasassa, FL (US)

(21) Appl. No.: 16/168,798

(22) Filed: Oct. 23, 2018

Related U.S. Application Data
(60) Provisional application No. 62/690,473, filed on Jun. 27, 2018.

(51) Int. Cl. B60J 11/06

(52) U.S. Cl. CPC B60J 11/06

(57) ABSTRACT

A portable scooter travel tiller cover is described.

### RELATED APPLICATIONS

This application claims the benefit of U.S. Application No. 62/690,473, entitled “Scooter Travel Tiller Cover,” and filed on Jun. 27, 2018, which is incorporated herein by reference in its entirety.

### TECHNICAL FIELD

Some implementations relate generally to portable electric motorized mobility scooters, and more particularly, to a mobility scooter tiller cover.

### BACKGROUND

People traveling with motorized mobility scooters (e.g., mobility scooters include scooters operable to assist user who may have an inability or difficulty walking) may often be concerned about possible damage occurring to the scooter, especially when traveling (e.g., on an airplane, train, bus, etc.). Sometimes, in the absence of the scooter owner, a mobility scooter (or simply “scooter”) may be mishandled, leading to damage occurring to the tiller mechanism, which may render the scooter inoperable until the damage is repaired.

When the tiller mechanism is damaged, the rear and forward gear levers may be left exposed. Further, improper handling of the damaged tiller mechanism can lead to extensive damages. Repairs may be required, costing a considerable amount of money. Accordingly, a device that is configured to completely cover the tiller while providing protection thereto may be desired. Some implementations were conceived in light of the above-mentioned problems or limitations, among other things.

### SUMMARY

Some implementations can provide a protective cover for a mobility scooter tiller. The mobility scooter travel tiller cover can include a flexible base that is adapted to be securable over a mobility scooter tiller. In some implementations, the base of the mobility scooter tiller cover can include a plurality of fasteners such as snaps, straps, hook and loop material, or the like, for securing the base to, over, and/or around, the tiller.

In some implementations, the mobility scooter tiller cover base includes a perimeter edge, including a closure member such as elastic, snaps, and/or hook and loop, operable to conform a bottom opening of the mobility scooter tiller cover to the size and shape of a given tiller such that the mobility scooter tiller cover base is removably securable via an elastic tension fit thereto.

The mobility scooter tiller cover base further includes one or more padded interior elements that contact the tiller (e.g., contact and partially surround a tiller paddle control) in order to prevent damage thereto. The mobility scooter tiller cover base includes at least one recession or apertures adapted to receive the paddle controls of the tiller. The padded portion of the mobility scooter tiller cover base can include a waterproof, durable material, and is operable to prevent damage to the tiller during transportation of the mobility scooter.

### BRIEF DESCRIPTION OF THE DRAWINGS

FIG. 1 is a diagram of an example portable mobility scooter and mobility scooter tiller cover in accordance with some implementations.

FIG. 2 is a diagram of an example portable scooter and mobility scooter tiller cover prior to installation on the scooter in accordance with some implementations.

FIG. 3 is a diagram of an example portable scooter and mobility scooter tiller cover prior to installation on the scooter in accordance with some implementations.

FIG. 4 is a diagram of a bottom view of an example mobility scooter tiller cover in accordance with some implementations.

FIG. 5 is a diagram of a cut away view of an example mobility scooter tiller cover installed on a mobility scooter tiller in accordance with some implementations.

### DETAILED DESCRIPTION

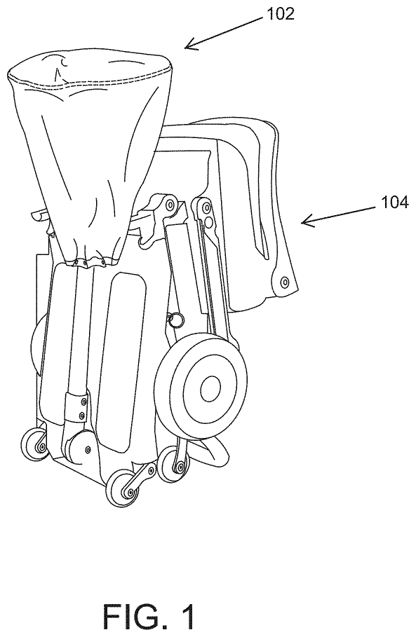

FIG. 1 is a diagram of an example portable mobility scooter 104 and mobility scooter tiller cover 102 in accordance with some implementations. As shown in FIG. 1, the mobility scooter tiller cover 102 is installed on a tiller (or control handle section) of the portable mobility scooter 104.

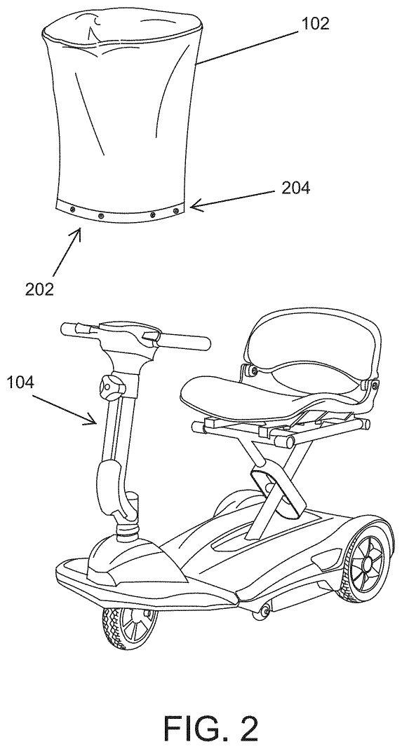

FIG. 2 is a diagram of an example portable scooter 104 and mobility scooter tiller cover 102 prior to installation on the scooter in accordance with some implementations. The mobility scooter tiller cover 102 includes a flexible base opening 202 and perimeter edge 204 having a closure member (e.g., snaps, hook and loop, elastic, a combination of the above, and/or the like). The mobility scooter tiller cover 102 is configured to be removably securable over a mobility scooter tiller.

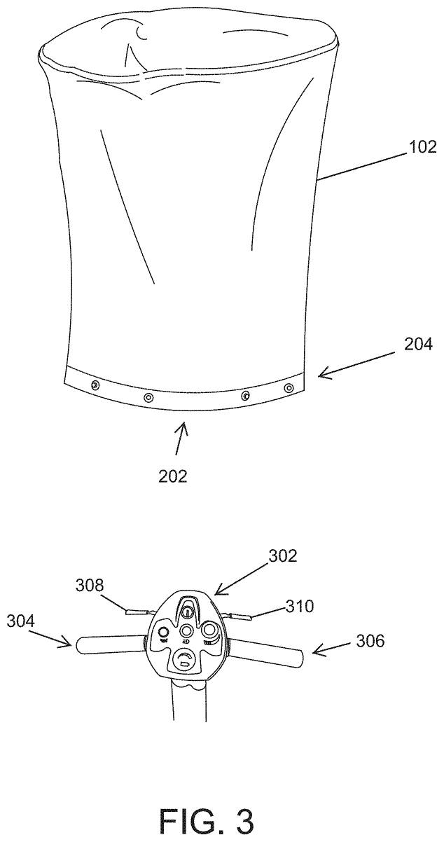

FIG. 3 is a diagram of an example portable scooter tiller and mobility scooter tiller cover prior to installation on the scooter in accordance with some implementations. In particular, FIG. 3 shows a mobility scooter tiller 302 having a plurality of handle grip members 304 and 306, and a plurality of paddle controls 308 and 310.

The mobility scooter tiller cover base 202 comprises a perimeter edge 204 that is configured to conform to the size and shape of the tiller 302 such that the base is removably securable via fasteners and/or elastic. In some implementations, the mobility scooter tiller cover base 202 perimeter edge 204 can include a plurality of fasteners such as snaps (shown in FIG. 3), straps, hook and loop material, or the like, for securing the base to the tiller.

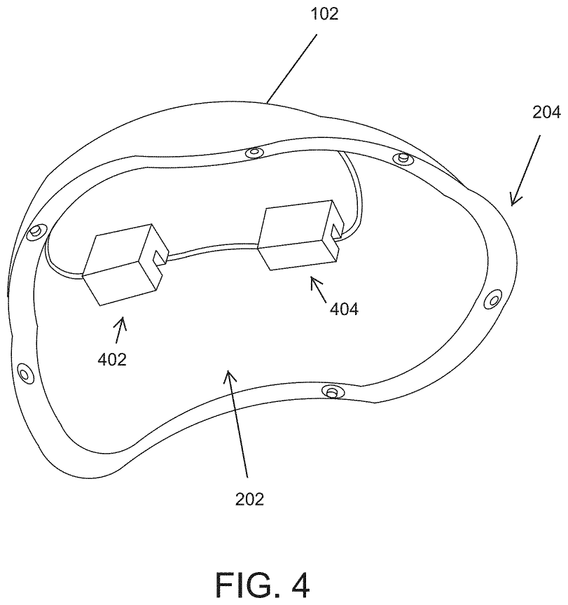

FIG. 4 is a diagram of a bottom view of an example mobility scooter tiller cover in accordance with some implementations. FIG. 4 shows the mobility scooter tiller cover base 202 open along the perimeter 204 to reveal an interior of the mobility scooter tiller cover. Within the interior, a plurality of protective blocks 402 and 404 each having a recession or aperture constructed to, and operable to, receive a respective one of the paddle controls (e.g., 308/310) of the tiller 302, such that the tiller 302 and the paddle controls are maintained in a stable position thereby and protected by the protective blocks 402 and 404. The protective blocks (402 and 404) are composed of a foam material, or any other suitable material.

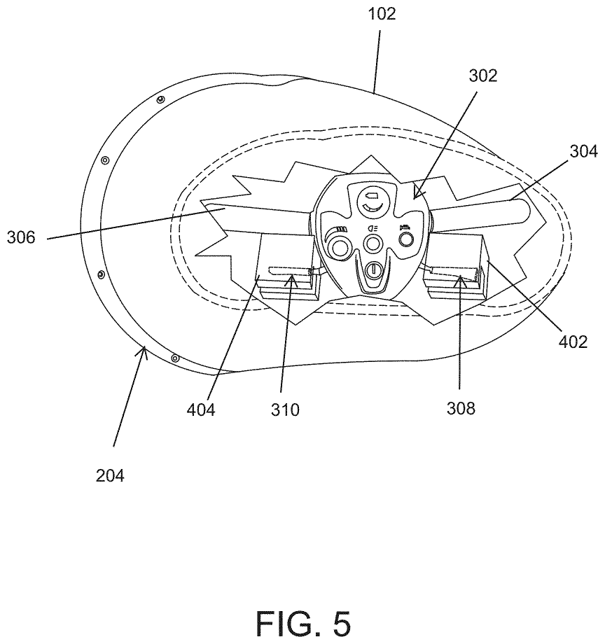

FIG. 5 is a diagram of a cut away view of an example mobility scooter tiller cover installed on a scooter tiller 302 and showing the tiller paddle controls (e.g., 308 and 310) inserted within protective blocks (402 and 404). The handle grips 304 and 306 are also shown.

In some implementations, the mobility scooter tiller cover 102 can include a padded body portion and can include a waterproof, durable exterior material that is configured to prevent damage to the tiller during transportation of the mobility scooter.

In some implementations, an exterior surface of the mobility scooter tiller cover can be composed of leather, canvas, or waxed canvas. In some implementations, the exterior surface of the mobility scooter tiller cover can be composed of a synthetic material such as faux leather, vinyl or any other suitable material.

In some implementations, the mobility scooter tiller cover is configured to completely cover the mobility scooter tiller thereby protecting the scooter tiller and providing convenience and comfort to a user thereof.

It is, therefore, apparent that there is provided, in accordance with the various implementations disclosed herein, a portable scooter travel tiller cover.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A mobility scooter tiller cover comprising:
a body portion having a flexible base opening with a perimeter edge, wherein the perimeter edge includes a closure member; and
a plurality of protective blocks attached to an interior of the body portion, each protective block having an aperture operable to receive a respective one of a plurality of mobility scooter tiller paddle controls, when the mobility scooter tiller cover is installed on a mobility scooter tiller.

2. The mobility scooter tiller cover of claim 1, wherein the perimeter edge is securable to the mobility scooter tiller via one or more of: one or more fasteners or an elastic member.

3. The mobility scooter tiller cover of claim 2, wherein the one or more fasteners include one or more of snaps, straps, or hook and loop.

4. The mobility scooter tiller cover of claim 1, wherein the plurality of protective blocks are made of a foam material.

5. The mobility scooter tiller cover of claim 1, wherein the body portion is padded.

6. The mobility scooter tiller cover of claim 1, wherein the body portion is waterproof.

7. The mobility scooter tiller cover of claim 1, wherein the body portion is made from one of leather, canvas, or waxed canvas.

8. The mobility scooter tiller cover of claim 1, wherein the body portion is made from one of a synthetic material.
